(19) United States
(12) Patent Application Publication
(10) Pub. No.: US 2025/0310829 A1
(43) Pub. Date: Oct. 2, 2025

(54) Protocol Data Unit Set Based Quality of Service Handling Enhancement

(71) Applicant: Apple Inc., Cupertino, CA (US)

(72) Inventors: Ahmed M. SOLIMAN, Munich (DE); Ping-Heng KUO, London (GB); Sudeep MANITHARA VAMANAN, Uttenreuth (DE)

(21) Appl. No.: 19/091,178

(22) Filed: Mar. 26, 2025

Related U.S. Application Data
(60) Provisional application No. 63/569,820, filed on Mar. 26, 2024.

(51) Int. Cl. H04W 28/06; H04W 24/02; H04W 28/02

(52) U.S. Cl. CPC H04W 28/06; H04W 24/02; H04W 28/0284

(57) ABSTRACT

An apparatus configured to create user equipment (UE) preference information relating a preference of a UE to discard protocol data units (PDUs) within a PDU set and generate, for transmission to a network node, a message comprising the UE preference information, wherein the UE preference information is configured to be used by the network node to discard one or more PDUs within the PDU set.

### Priority/Incorporation By Reference

This application claims priority to U.S. Provisional Application Ser. No. 63/569,820 filed on Mar. 26, 2024, and entitled “Protocol Data Unit (PDU) Set Based Quality of Service (QOS) Handling Enhancement,” the entirety of which is incorporated by reference herein.

### BACKGROUND

Many electronic devices communicate with each other using wireless networks, The use of several types of systems has increased due to both an increase in the number and types of user equipment (UEs) using network resources as well as the amount of data and bandwidth being used by various applications, such as video streaming, operating on these UEs. Bandwidth, latency, and data rate enhancement may be used to deliver the continuously increasing demand for network resources. Cellular wireless communication systems, such as Fifth Generation (5G) networks, Sixth Generation (6G) networks and beyond, will provide ubiquitous connectivity and access to information, as well as the ability to share data, by various users and applications. These networks are expected to be a unified framework that targets to meet starkly different and sometimes conflicting performance criteria and services. Some aspects of the networks will evolve based on the Third Generation Partnership (3GPP) Long Term Evolution-Advanced (LTE-Advanced) technology with additional enhanced radio access technologies (RATs) to enable seamless wireless connectivity solutions. However, as with the advent of any new technology, many issues arise with the introduction and use of such technology.

In one example, the handling of protocol data unit (PDU) sets, particularly by the application layer on the receiver side, and Quality of Service (QOS) requirements in the NG radio access network (NG-RAN) may benefit from enhancements. There is a need for improved mechanisms and techniques for how PDU sets are handled in a way that more efficiently meets QoS requirements.

### SUMMARY

Some example embodiments are related to an apparatus having processing circuitry configured to create user equipment (UE) preference information relating a preference of a UE to discard protocol data units (PDUs) within a PDU set and generate, for transmission to a network node, a message comprising the UE preference information, wherein the UE preference information is configured to be used by the network node to discard one or more PDUs within the PDU set.

Other example embodiments are related to an apparatus having processing circuitry configured to process, based on signals received from a user equipment (UE), UE preference information relating to a preference of a UE to discard protocol data units (PDUs) within a PDU set, process, based on signals received from a network, configuration information that includes a PDU set discard configuration relating to which PDUs in the PDU set to discard and determine whether to discard one or more PDUs within the PDU set based at least in part on the UE preference information and the PDU set discard configuration.

Still further example embodiments are related to an apparatus having processing circuitry configured to process protocol data units (PDUs) within a PDU set and adaptively change a discard timer or discard timer value to be applied to discard PDUs within the PDU set.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows another example network arrangement, in accordance with various example embodiments.

FIG. 5 shows an example embodiment of a PDU set according to various example embodiments.

FIG. 6 is an example diagram illustrating how a preference of a UE may be communicated to a network according to various example embodiments.

FIG. 7 is an example diagram illustrating how multiple discarding levels may be set in a network according to various example embodiments.

FIG. 8 is an example flow diagram illustrating a method of adaptively changing a discard timer for PDUs within a PDU Set according to various example embodiments.

### DETAILED DESCRIPTION

The example embodiments may be further understood with reference to the following description and the related appended drawings, wherein like elements are provided with the same reference numerals. The example embodiments relate to enhancements to PDU set based Qos handling that includes enhancements to the discarding logic by considering one or more preference(s) of a UE, using different discarding levels, and adapting a discard timer or discard timer value. Each of these example embodiments will be described in greater detail below.

The example embodiments are described with regard to a UE. However, reference to a UE is merely provided for illustrative purposes. The example embodiments may be utilized with any electronic component that may establish a connection to an accessory device and is configured with the hardware, software, and/or firmware to exchange information and data with accessory devices. Therefore, the UE as described herein is used to represent any electronic component.

The example embodiments are also described with reference to a 5G New Radio (NR) network. However, the example embodiments may also be implemented in other types of networks, including but not limited to LTE networks, future evolutions of the cellular protocol (e.g., 5G-advanced networks, 6G networks, etc.), or any other type of network.

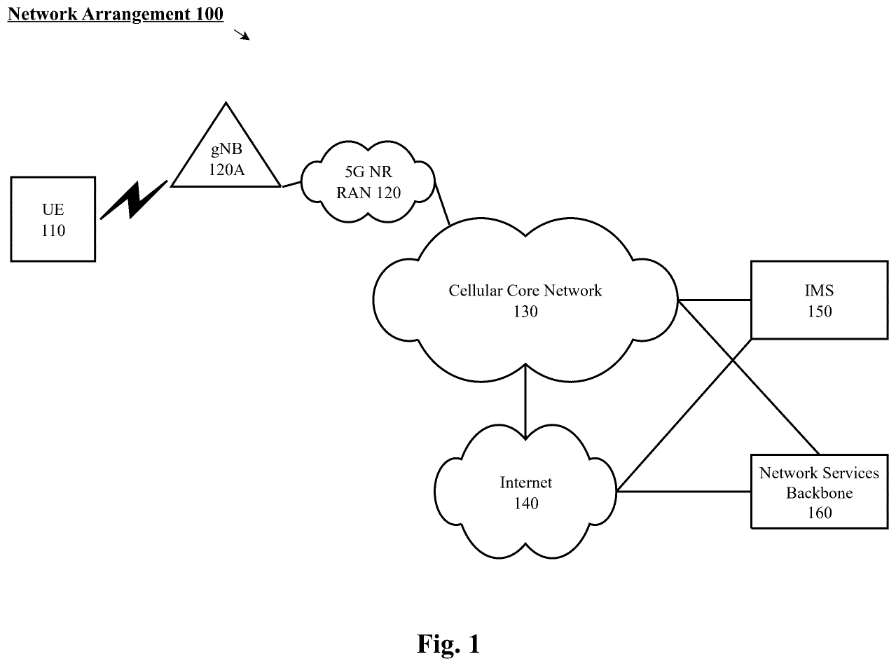

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, embedded devices, wearables, Internet of Things (IoT) devices, etc. An actual network arrangement may include any number of UEs being used by any number of users. Thus, the example of one UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a legacy cellular network, etc.) and the UE 110 may also communicate with networks over a wired connection. With regard to the example embodiments, the UE 110 may establish a connection with the 5G NR RAN 120. Therefore, the UE 110 may have a 5G NR chipset to communicate with the NR RAN 120.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A and the gNB 120B. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

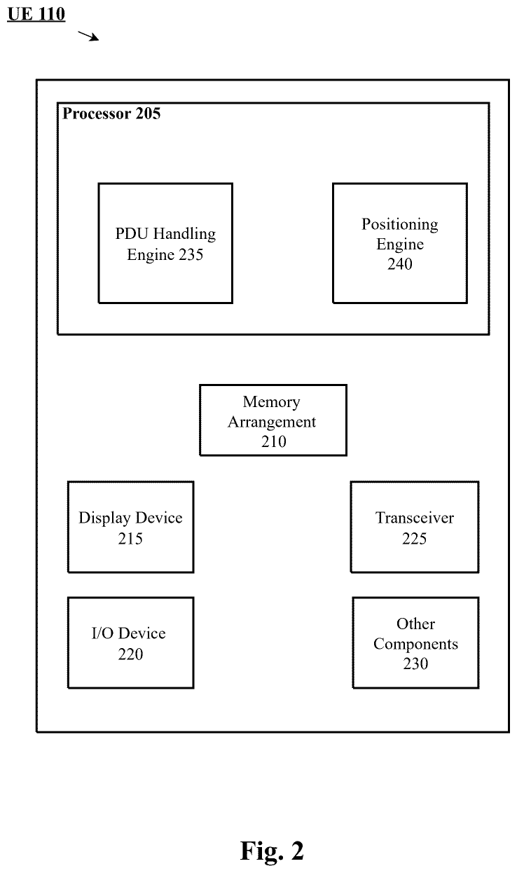

FIG. 2 shows an example UE 110 according to various example embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a PDU Handling engine 235 for performing operations related to PDU set based Qos handling. For example, the PDU Handling engine 235 may include logic and/or circuitry that creates preferences for PDU Set Discard rules and/or multiple discard levels for the discarding of PDUs and causes the preferences and/or discard levels to be transmitted to a network. The PDU Handling engine 235 may also include logic and/or circuitry that implements a discard timer and/or logic and/or circuitry for adapting a discard timer or discard timer value that is used in the discarding of PDUs, to be described in further detail below. Each of these example operations will be described in more detail below. The engines may also include a positioning engine 240 for transmitting positioning signals to each of a plurality of positioning nodes based on a network configuration for the positioning signals. The positioning signals are estimated by the positioning nodes to provide the network with information so that the network may determine a location of the UE.

The above referenced engines 235 and 240 being applications (e.g., programs) executed by the processor 205 is only an example. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

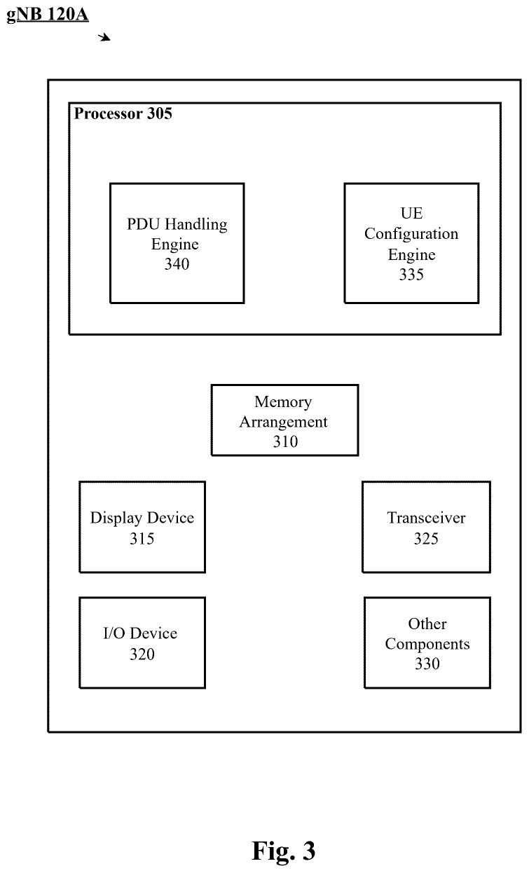

FIG. 3 shows an example base station 300 according to various example embodiments. The base station 300 may represent the gNB 120A, the gNB 120B or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the UE 110. For example, when the qNB 120A is a serving cell for a UE, the engines may include a UE configuration engine 335 for providing UE configuration information to the network. The network may then distribute the information to positioning nodes so that the positioning nodes may monitor. In addition, the engines may include a PDU Handling engine 340 for performing operations related to PDU set based QoS handling. For example, the PDU Handling engine 340 may include logic and/or circuitry that creates and transmits configuration information that includes PDU Set Discard rules and/or multiple discard levels for the discarding of PDUs and causes PDUs to be discarded based on the preferences and/or discard levels. The PDU Handling engine 340 may also include logic and/or circuitry for implementing a discard timer and/or logic and/or circuitry for adapting a discard timer or discard timer value that is used in the discarding of PDUs, to be described in further detail below. Each of these example operations will be described in more detail below. Though engines 335 and 340 are shown as separate engines, in some embodiments, engines 335 and 340 may be combined into a single engine.

The memory arrangement 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the network arrangement 100. The transceiver 320 may operate on a variety of different frequencies or channels (e.g., set of consecutive frequencies). The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

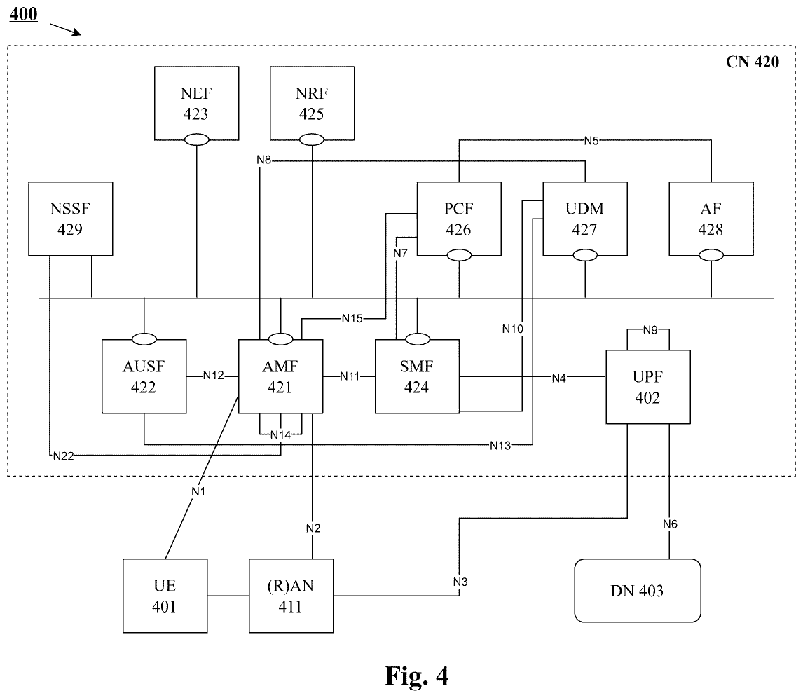

FIG. 4 shows an architecture of a system 400 of a network in accordance with some example embodiments.

The system 400 is shown to include a UE 401, which may be similar to UE 110 discussed previously; a RAN node 411; a Data network (DN) 403, which may be, for example, operator services, Internet access or 3rd party services; and a 5G Core Network (5GC or CN) 420.

The CN 420 may include an Authentication Server Function (AUSF) 422; an Access and Mobility Management Function (AMF) 421; a Session Management Function (SMF) 424; a Network Exposure Function (NEF) 423; a Policy Control Function (PCF) 426; a Network Function (NF) Repository Function (NRF) 425; a Unified Data Management (UDM) 427; an Application Function (AF) 428; a User Plane Function (UPF) 402; and a Network Slice Selection Function (NSSF) 429.

The UPF 402 may act as an anchor point for intra-RAT and inter-RAT mobility, an external PDU session point of interconnect to DN 403, and a branching point to support multi-homed PDU session. The UPF 402 may also perform packet routing and forwarding, packet inspection, enforce user plane part of policy rules, lawfully intercept packets (UP collection); traffic usage reporting, perform QoS handling for user plane (e.g. packet filtering, gating, UL/DL rate enforcement), perform Uplink Traffic verification (for example, SDF to QoS flow mapping), transport level packet marking in the uplink and downlink, and downlink packet buffering and downlink data notification triggering. UPF 402 may include an uplink classifier to support routing traffic flows to a data network. The DN 403 may represent various network operator services, Internet access, or third party services. The UPF 402 may interact with the SMF 424 via an N4 reference point between the SMF 424 and the UPF 402.

The AUSF 422 may store data for authentication of UE 401 and handle authentication related functionality. The AUSF 422 may facilitate a common authentication framework for various access types. The AUSF 422 may communicate with the AMF 421 via an N12 reference point between the AMF 421 and the AUSF 422; and may communicate with the UDM 427 via an N13 reference point between the UDM 427 and the AUSF 422.

The AMF 421 may be responsible for registration management (for example, for registering UE 401, etc.), connection management, reachability management, mobility management, and lawful interception of AMF-related events, and access authentication and authorization. The AMF 421 may be a termination point for the N11 reference point between the AMF 421 and the SMF 424. The AMF 421 may provide transport for Session Management (SM) messages between the UE 401 and the SMF 424, and act as a transparent proxy for routing SM messages. AMF 421 may also provide transport for short message service (SMS) messages between UE 401 and an SMS function (SMSF) (not shown by FIG. 4), AMF 421 may act as Security Anchor Function (SEA), which may include interaction with the AUSF 422 and the UE 401, receipt of an intermediate key that was established as a result of the UE 401 authentication process. Furthermore, AMF 421 may be a termination point of RAN CP interface, which may include or be an N2 reference point between the RAN 411 and the AMF 421; and the AMF 421 may be a termination point of NAS (N1) signaling and perform NAS ciphering and integrity protection.

AMF 421 may also support NAS signaling with a UE 401 over an N3 interworking-function (IWF) interface. The N3IWF may be used to provide access to untrusted entities. N3IWF may be a termination point for the N2 interface between the (R) AN 411 and the AMF 421 for the control plane and may be a termination point for the N3 reference point between the (R) AN 411 and the UPF 402 for the user plane. As such, the AMF 421 may handle N2 signaling from the SMF 424 and the AMF 421 for PDU sessions and QoS, encapsulate/de-encapsulate packets for IPSec and N3 tunnelling, mark N3 user-plane packets in the uplink, and enforce QoS corresponding to N3 packet marking taking into account QoS requirements associated to such marking received over N2.

The UE 401 may need to register with the AMF 421 in order to receive network services. Registration Management (RM) is used to register or deregister the UE 401 with the network (for example, AMF 421), and establish a UE context in the network (for example, AMF 421).

The SMF 424 may be responsible for session management (for example, session establishment, modify and release, including tunnel maintain between UPF and AN node); UE IP address allocation & management (including optional Authorization); Selection and control of UP function; Configures traffic steering at UPF to route traffic to proper destination; termination of interfaces towards Policy control functions; control part of policy enforcement and QOS; lawful intercept (for SM events and interface to LI System); termination of SM parts of NAS messages; downlink Data Notification; initiator of AN specific SM information, sent via AMF over N2 to AN; determine SSC mode of a session. The SMF 224 may include the following roaming functionality: handle local enforcement to apply QOS SLAB (VPLMN); charging data collection and charging interface (VPLMN); lawful intercept (in VPLMN for SM events and interface to LI System); support for interaction with external DN for transport of signaling for PDU session authorization/authentication by external DN. An N16 reference point between two SMEs 424 may be included in the system 200, which may be between another SMF 424 in a visited network and the SMF 424 in the home network in roaming scenarios.

The NEF 423 may provide means for securely exposing the services and capabilities provided by 3GPP network functions for third party, internal exposure/re-exposure, Application Functions (for example, AF 428), edge computing or fog computing systems, etc. In such embodiments, the NEF 423 may authenticate, authorize, and/or throttle the AFs. NEF 423 may also translate information exchanged with the AF 428 and information exchanged with internal network functions. For example, the NEF 423 may translate between an AF-Service-Identifier and an internal 5GC information.

The NRF 425 may support service discovery functions, receive NF Discovery Requests from NF instances, and provide the information of the discovered NF instances to the NF instances, NRF 425 also maintains information on available NF instances and their supported services.

The PCF 426 may provide policy rules to control plane function(s) to enforce them and may also support a unified policy framework to govern network behavior, The PCF 426 may also implement a front end (FE) to access subscription information relevant for policy decisions in a UDR of the UDM 427. The PCF 426 may communicate with the AMF 421 via an N15 reference point between the PCF 426 and the AMF 421, which may include a PCF 426 in a visited network and the AMF 421 in case of roaming scenarios. The PCF 426 may communicate with the AF 428 via an N5 reference point between the PCF 426 and the AF 428; and with the SMF 424 via an N7 reference point between the PCF 426 and the SMF 424.

The UDM 427 may handle subscription-related information to support the network entities' handling of communication sessions and may store subscription data of UE 401. For example, subscription data may be communicated between the UDM 427 and the AMF 421 via an N8 reference point between the UDM 427 and the AMF 421 (not shown by FIG. 4), The UDM M 427 may include two parts, an application FE and a User Data Repository (UDR) (the FE and UDR are not shown by FIG. 4). The UDR may store subscription data and policy data for the UDM 427 and the PCF 426, and/or structured data for exposure and application data (including Packet Flow Descriptions (PFDs) for application detection, application request information for multiple UEs 401) for the NEF 423.

The AF 428 may provide application influence on traffic routing, access to the Network Capability Exposure (NCE), and interact with the policy framework for policy control, The NCE may be a mechanism that allows the 5GC and AF 428 to provide information to each other via NEF 423, which may be used for edge computing implementations. In such implementations, the network operator and third party services may be hosted close to the UE 401 access point of attachment to achieve an efficient service delivery through the reduced end-to-end latency and load on the transport network. For edge computing implementations, the 5GC may select a UPF 402 close to the UE 401 and execute traffic steering from the UPF 402 to DN 403 via the N6 interface. This may be based on the UE subscription data, UE location, and information provided by the AF 428. In this way, the AF 428 may influence UPF (re) selection and traffic routing, Based on operator deployment, when AF 428 is considered to be a trusted entity, the network operator may permit AF 428 to interact directly with relevant NFS.

The NSSF 429 may select a set of network slice instances serving the UE 401. The NSSF 429 may also determine allowed Network Slice Selection Assistance Information (NSSAI) and the mapping to the Subscribed Single-NSSAIS (S-NSSAIs), if needed. The NSSF 429 may also determine the AMF set to be used to serve the UE 401, or a list of candidate AMF(s) 421 based on a suitable configuration and by querying the NRF 425. The selection of a set of network slice instances for the UE 401 may be triggered by the AMF 421 with which the UE 401 is registered by interacting with the NSSF 429, which may lead to a change of AMF 421.

Now, turning to how PDU handling can be enhanced in the above-described systems, the example embodiments disclosed herein relate to proposed enhancements to PDU set based Qos handling that includes enhancements to the discarding logic by considering one or more preference(s) of a UE, using different discarding levels, and adapting a discard timer or discard timer value. Each of these example embodiments will be described in greater detail below.

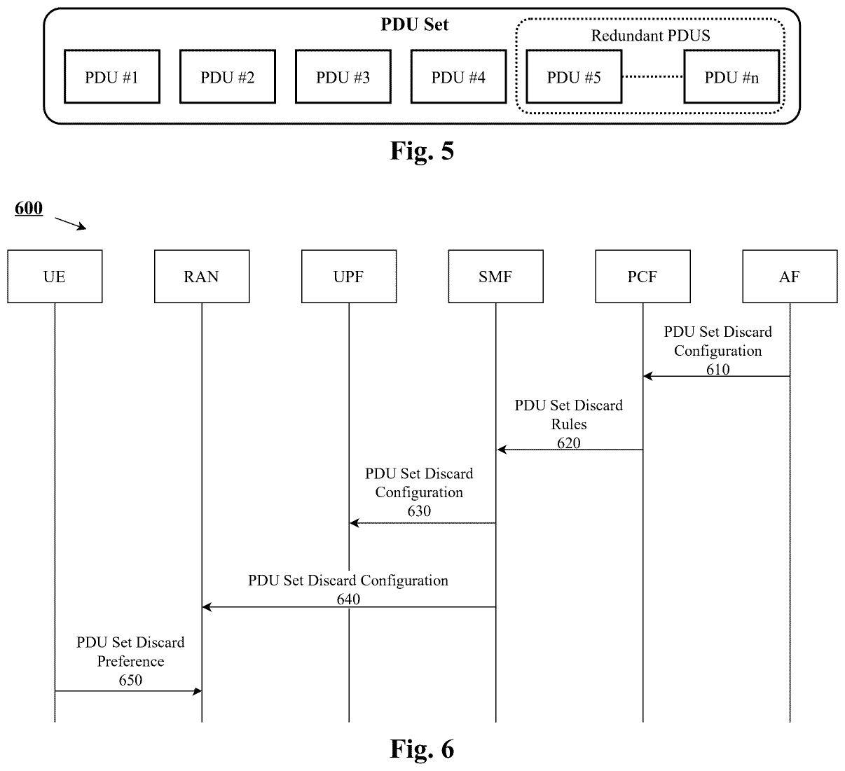

As mentioned, per Release 18, 3GPP TR 23.700-70, a set of rules have been discussed regarding support of PDU Set Based QOS Handling. The PDU Set Integrated Handling Information (PSIHI) indicates whether all PDUs of the PDU Set are needed for the usage of the PDU Set by the application layer in the receiver side. PSIHI is an optional parameter. A QOS Flow is associated with at most one PSIHI value per direction. With Forward Error Correction (FEC) mechanisms, the application layer may add redundant data to be able to recover from some data loss scenarios, as seen in FIG. 5. FIG. 5 is an example embodiment of a PDU set according to various example embodiments. In the example of FIG. 5, a PDU set comprises PDU #1 through PDU #n, where PDU #5 through PDU #n are redundant PDUs. If some PDUs are not needed for the usage of the PDU set by the application layer in the receiver side, the NG-RAN or other network node can discard these PDUs when needed, such as for Qos purposes (e.g., in a congestion scenario).

However, the proposed PSIHI rules do not consider the UE preference in the PDU set discarding decision(s). Currently, PDU discarding decisions are network based. It may be beneficial for the UE to have preferences that are considered in the PDU set discarding decisions. In addition, other enhancements for the handling of the PDU set cased QOS may include different discarding levels and the use of an adapted discard timer for enhancing PDU set discarding. These enhancements may be used individually or in any combination with each other.

A first set of proposed enhancements to the PDU set based Qos handling includes enhancements to the discarding logic by considering the UE preference(s). For example, in one embodiment, the UE may/may not prefer discarding redundant/non-mandatory PDUs due to different aspects including but not limited to: a UE power status, whether or not the UE is the last node or not in a relay situation, and a computational status of the UE.

In some example embodiments, the UE power status may include a battery level and power status of the UE, which may control the UE discarding preference. For example, if the UE is in a lower power mode, or has a low battery level, the UE may not have enough power resources to process error correction and thus can discard redundant PDUs since it will not be performing error correction. In other example embodiments, discarding of the PDUs should be avoided if the UE is not the last node (e.g., the UE is acting as a relay to forward the data to another device). If the UE is not the last node and is acting to relay data to another wireless device, it may become more important that the PDUs not be discarded. In still further example embodiments, the computation status of the UE may be considered, where the UE preference may be changed based on the computation cost to recover from discarded PDUs, and the UE internal status. For example, the UE may have heavy computational tasks to perform, or the thermal condition of the UE may affect the ability of the UE to perform tasks. So, the UE has to consider the computational cost for each application, and the computation cost may affect the UE's preference for PDU discarding.

Based on the above aspects that may affect the preferences of the UE with regard to discarding of PDUs, the UE may create UE preference information relating to discarding of PDUs within a PDU set and transmit the UE preference information to the RAN, gNB, or another network node. The UE preference information may be used by the network node to decide whether to discard one or more of the subsequent PDUs within the PDU set.

In one embodiment, the UE can provide its preference to the NG-RAN or other network node using UEAssistanceInformation or any other RRC message. Based on the UE preference, Application Function (AF) configuration, transmission status, network status, and/or the network internal logic, a NG-RAN or other network node may decide to discard some PDUs and may identify which PDUs to discard. In some embodiments, the UE may change its discarding preference(s) during run time. In this case, the UE may create updated UE preference information relating to discarding subsequent PDUs within a PDU set and transmit the updated UE preference information to the network node. The updated UE preference information may then be used by the network node to discard one or more of the subsequent PDUs within the PDU set.

FIG. 6 is an example diagram illustrating how a preference of a UE may be communicated to a network according to various example embodiments. In a method 600 as shown in FIG. 6, an application function (AF) (such as AF 428) may transmit configuration information to a Policy Control Function (PCF) (such as PCF 446), where the configuration information may include PDU Set Discard Rules (610). The PCF may forward the PDU Set Discard Rules to a Session Management Function (SMF) (such as SMF 424) (620). The SMF may transmit the PDU Set Discard Configuration information to a User Plane Function (UPF) (such as UPF 402) (630) and to a RAN (such as RAN 120 or RAN 411) (640). The UE (such as UE 110 or UE 401) may send the PDU Set Discard Preference to the RAN (650). As mentioned above, the preference may be sent to the RAN or other network node using UEAssistanceInformation or any other RRC message. Although FIG. 6 shows the UE initiating the transmission of the UE's PDU Set Discard Preference to the RAN (network node), in another embodiment, the network node (RAN or gNB) may ask the UE if it has any discarding preferences and the UE may respond with its discarding preferences.

The UE may inform the NG-RAN or other network node about one or more of the following preferences: Discard Recommended; Discard Fine (OK), and Discard Not Recommended. Discard Fine (OK) means that discarding is accepted or allowable, such that it is OK to discard or not to discard. If the UE preference is that discard is recommended, the NG-RAN or other network node may discard PDUs even if there is no congestion. If the UE preference is that discard is not recommended, the NG-RAN or other network node may discard PDUs only if absolutely necessary to avoid total data loss. In some example embodiments, the UE may indicate a preferred minimum number of PDUs in a PDU Set that are already successfully delivered, before the whole PDU Set can be discarded. In other example embodiments, the UE may indicate a preferred discarding level to the NG-RAN, as well be discussed in more detail below.

Other preferences of the UE may also be sent to the network. For example, the UE may indicate it prefers to apply PDU Set discarding when congestion is detected, or when a certain amount of congestion is detected. In another example, the UE may indicate it prefers to apply PDU Set discarding when the PDU Set Importance (PSI)-based discarding mechanism for the corresponding Data Radio Bearer (DRB) is activated. In another example, the UE may indicate it prefers to apply PDU Set discarding when a threshold number of previous consecutive PDU Sets (previous K consecutive PDU Sets) are already lost/discarded or successfully delivered, where K is a positive integer. In another embodiment, the UE may indicate it prefers to apply PDU Set discarding when a threshold number of previous PDU Sets (previous K PDU Sets) are already lost/discarded within a specific time interval (e.g., 5 PDU Sets are lost in the last 40 ms).

A second set of proposed enhancements to the PDU set based Qos handling includes enhancements to the discarding logic by considering different levels of discarding.

For example, in some example embodiments, PDUs in a PDU set could be split or divided among different categories, such as mandatory PDUs, redundant PDUs, and recommended PDUs. In some example embodiments, mandatory PDUs might include all PDUs of the PDU Set which are needed for the usage of the PDU Set by the application layer in the receiver side to have successful PDU set delivery. In some example embodiments, redundant PDUs may include PDUs of the PDU Set which are not needed for the usage of the PDU Set by the application layer in the receiver side (e.g., redundant FEC PDUs). In some example embodiments, recommended PDUs might include PDUs of the PDU Set which are needed for high quality usage of the PDU Set by the application layer in the receiver side. For example, the recommended PDUs are not mandatory, but they will enhance the quality of the received data. Without recommended PDUs, the PDU set could be considered as successfully received but the quality will be impacted. Thus, when high quality is needed or desired (e.g., video streaming), the recommended PDUs would include the PDUs to make high quality PDU transmission possible.

The AF may prefer to split or further divide the recommended PDUs among different levels and configure the network (such as the 5G Core network, or 5GC) with multiple levels. So, there may be different levels of recommended PDUs based on how highly recommended the PDUs are for enhancement of the quality of the data to be delivered. In some example embodiments, the AF may inform the 5GC about the PDUs which could be discarded per PDU set. The AF may inform the 5GC with n different levels of allowed discarding. For example, a first level of discarding (L1) may allow discarding of about ten percent (10%) of PDUs (e.g., discard redundant PDUs). In a second discarding level (L2), up to about twenty percent (20%) of PDUs may be discarded (e.g., discard redundant PDUs and a subset of recommended PDUs such that quality may be impacted by a certain amount, which may be five percent (5%) in one embodiment. In an nth discarding level (Ln), up to thirty-five percent (35%) of PDUs might be discarded. Despite the number of levels and percentage of PDUs that might be discarded in each level that are discussed above, any number of discarding levels and any percentage of discarding of PDUs in each level may be used, and the examples described herein are not meant to be limiting. The different levels of discarding allow the RAN, gNB or other network node to do an analysis of what resources will be saved if the PDU is discarded versus the impact discarding the PDU may have on the quality of the received data. In this way, a more informed decision may be made regarding whether to discard the PDU.

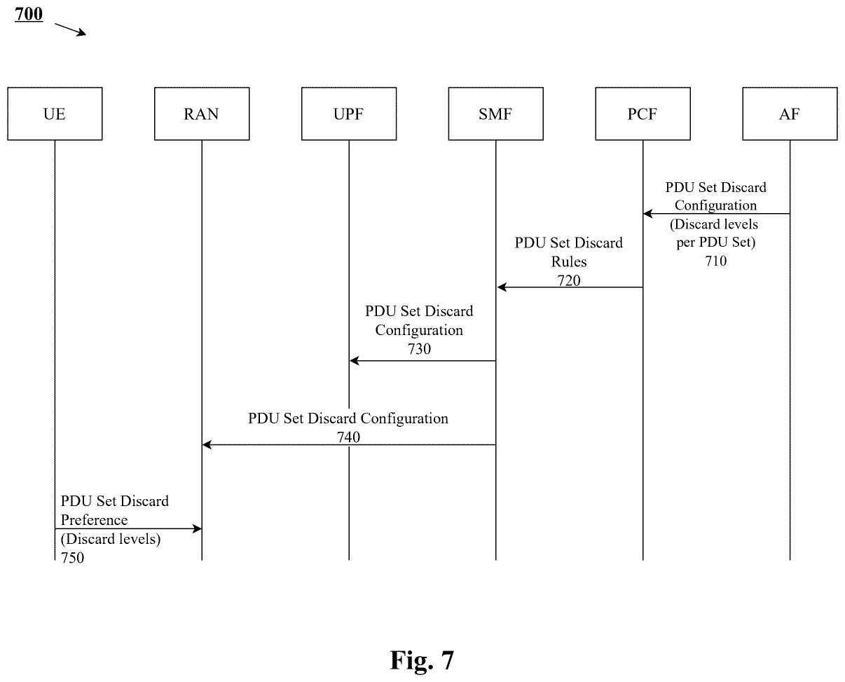

FIG. 7 is an example diagram illustrating how multiple discarding levels may be set in a network according to various example embodiments. In a method 700 as shown in FIG. 7, an AF (such as AF 428) may transmit PDU Set Discard configuration information to the PCF (such as PCF 426), where the configuration information may include one or more discard level(s) for each PDU Set (710). The PCF may create PDU Set Discard Rules based on the PDU Set Discard configuration information and forward it with the discard level information to a SMF (such as SMF 424) (720). The SMF may transmit the PDU Set Discard Configuration information with the discard levels to a UPF (such as UPF 402) (630) and to a RAN (such as RAN 120 or RAN 411) (740). The UE (such as UE 110 or UE 401) may also send a PDU Set Discard Preference with one or more discard levels to the RAN (750). In one embodiment, the UE may attempt to match the discard levels in its preference to the discard levels per PDU set included in the PDU Set Discard Configuration of the AF. As mentioned above, the preference may be sent to the RAN using UEAssistanceInformation or any other RRC message.

In some example embodiments, the UE may provide the NG-RAN or other network node with a UE discarding preference, and the UE may provide one or more discarding levels within the discarding preference. For example, the UE may provide the NG-RAN or other network node a recommended discarding level within the discarding preference. In other example embodiments, the AF may provide the discarding levels to the network. In some example embodiments, the UE may request from the NG-RAN or other network node to switch between discarding levels during run time. Based on UE preference (which includes the discard level(s), the AF configuration, transmission status, network status, and/or the network internal logic, the NG-RAN or other network node may decide to discard some PDUs. For example, in high load scenarios (before congestion), the NG-RAN may discard the redundant PDUs and transmit mandatory and recommended PDUs to avoid any impact on the quality of the received data. In high congestion scenarios, the NG-RAN or other network node may discard both redundant and recommended PDUs and transmit only mandatory PDUs.

A third set of proposed enhancements to the PDU set based Qos handling includes adapting a discard timer or discard timer value. A discard timer is normally used to discard any data that has stayed in the uplink buffer for more than a time value as set by the discard timer.

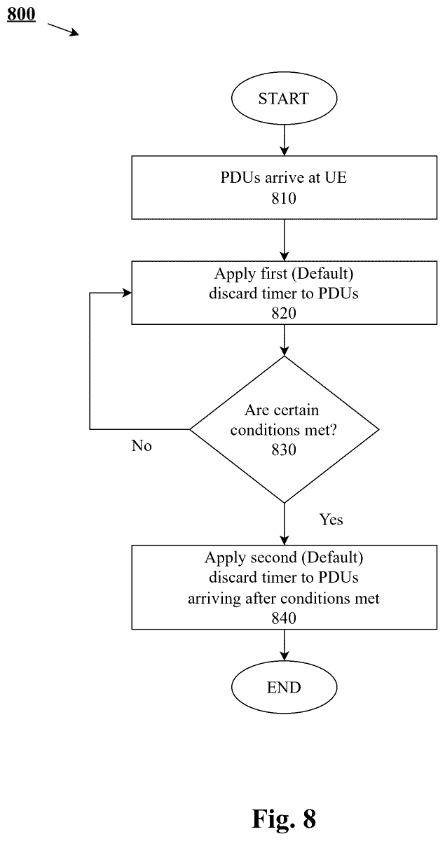

A method is proposed for a UE to adaptively change the discard timer (or discard timer value) for PDUS within a PDU Set. FIG. 8 is an example flow diagram illustrating a method 800 of adaptively changing a discard timer for PDUs within a PDU Set according to various example embodiments. Certain assumptions may need to be met. For example, the PDUs of a PDU Set do not arrive at the same time from the upper layer. At the beginning, when first PDUs arrive at the UE (810), the UE applies the first (or default) discard timer to the PDUs of a PDU Set (820). The UE then periodically or continually checks to see if certain delivery conditions are met (830). When certain delivery conditions are met, the UE applies the second discard timer (or second value) to the PDUs of the PDU Set that arrives subsequently (840). The delivery conditions may include: (1) when a threshold number N PDUs of this PDU Sets are already successfully delivered; (2) when a threshold number N PDUs of this PDU Sets are already lost or discarded; (3) when a threshold number N specific type(s) or category/categories of PDUs of this PDU Sets are already successfully delivered; and/or (4) when a threshold number N specific type(s) or category/categories of PDUs of this PDU Sets are already lost or discarded. In one embodiment, both the first and second discard timer (or first and second values) can be pre-configured. In one embodiment, both the first and second discard timer values might be zero. In another embodiment, the first and second discard timer values may always be different.

In some example embodiments, this scheme may only be applicable to PDU Sets with specific importance/priority levels (e.g., it might only be applicable to PDU Sets with PDU Set Importance (PSI) higher or lower than a threshold, or it might only be applicable to important or less-important PDU Sets). In other example embodiments, this scheme may only apply when such behavior is activated by the network based on certain indication(s), such as only when a PSI-based discarding mechanism for the corresponding DRB is activated. In some example embodiments, the scheme may only apply when congestion is present.

### EXAMPLES

In a first example, a method, comprising creating user equipment (UE) preference information relating a preference of a UE to discard protocol data units (PDUs) within a PDU set and generating, for transmission to a network node, a message comprising the UE preference information, wherein the UE preference information is configured to be used by the network node to discard one or more PDUs within the PDU set.

In a second example, the method of the first example, wherein the UE preference information is based on a battery level and/or power status of a UE.

In a third example, the method of the first example, wherein the UE preference information is based on whether a UE is acting as a last node in relaying data to another device.

In a fourth example, the method of the first example, wherein the UE preference information is based on a computation cost to recover from discarded PDUs and an internal status of a UE.

In a fifth example, the method of the first example, wherein the UE preference information is transmitted to the network node via a UEAssistanceInformation or other Radio Resource Control (RRC) message.

In a sixth example, the method of the first example, wherein the UE preference information changes over time and the method further comprises creating updated UE preference information relating to discarding of subsequent PDUs within the PDU set and generating, for transmission to the network node, a further message cause comprising the updated UE preference information, wherein the updated UE preference information is configured to be used by the network node to discard one or more of the subsequent PDUs within the PDU set.

In a seventh example, the method of the first example, wherein the UE preference information comprises a recommendation to discard redundant or non-mandatory PDUs.

In an eighth example, the method of the first example, wherein the UE preference information comprises an indication that discarding redundant or non-mandatory PDUs is allowable.

In a ninth example, the method of the first example, wherein the UE preference information comprises a recommendation that redundant or non-mandatory PDUs not be discarded.

In a tenth example, the method of the first example, wherein the UE preference information comprises an indication of a preferred minimum number of PDUs in the PDU set that are successfully delivered before PDUs in the PDU set are to be discarded.

In an eleventh example, the method of the first example, wherein the UE preference information further comprises an indication that PDU discarding is to be performed when congestion is detected at the network node.

In a twelfth example, the method of the first example, wherein the UE preference information further comprises an indication that PDU discarding is to be performed when a PDU Set Importance (PSI)-based discarding mechanism for a corresponding Data Radio Bearer (DRB) is activated.

In a thirteenth example, the method of the first example, wherein the UE preference information further comprises an indication that PDU discarding is to be performed when a threshold number of previous consecutive PDU Sets are already lost, discarded, or successfully delivered.

In a fourteenth example, the method of the first example, wherein the UE preference information further comprises an indication that PDU discarding is to be performed when a threshold number of previous PDU Sets have been lost and/or discarded within a specific time interval.

In a fifteenth example, the method of the first example, wherein the UE preference information comprises at least one level of discarding for each category of PDUs.

In a sixteenth example, the method of the fifteenth example, wherein each of the categories of PDU has a different level of discarding and each PDU of the PDUs in the PDU set is divided into one of mandatory PDUs, redundant PDUs, and recommended PDUs.

In a seventeenth example, the method of the sixteenth example, wherein the recommended PDUs are divided further into multiple different levels of discarding and the UE preference information comprises the multiple different levels to discard the recommended PDUs.

In an eighteenth example, the method of the fifteenth example, wherein the at least one level of discarding for each of the categories of PDUs changes over time and the method further comprises creating updated UE preference information relating to discarding of subsequent PDUs within the PDU set, the updated UE preference information comprising an updated level of discarding for each of the categories of PDUs and generating, for transmission to the network node, a message comprising the updated UE preference information with the updated level of discarding, wherein the updated UE preference information and updated level of discarding is configured to be used by the network node to discard one or more of the subsequent PDUs within the PDU set.

In a nineteenth example, the method of the first example, wherein the method comprises adaptively changing a discard timer or discard timer value to be applied to discard PDUs within the PDU set.

In a twentieth example, the method of the nineteenth example, further comprising applying a first discard timer or first discard timer value to PDUs within the PDU set, determining if one or more delivery conditions are met and, when the one or more delivery conditions are met, applying a second discard timer or second discard timer value to subsequent PDUS of the PDU set.

In a twenty first example, the method of the twentieth example, wherein the one or more delivery conditions comprises a threshold number of PDUs of the PDU set having been successfully delivered.

In a twenty second example, the method of the twentieth example, wherein the one or more delivery conditions comprises a threshold number of PDUs having been lost or discarded.

In a twenty third example, the method of the twentieth example, wherein the one or more delivery conditions comprises a threshold number of specific category or categories of PDUs of the PDU set having been successfully delivered.

In a twenty fourth example, the method of the twentieth example, wherein the one or more delivery conditions comprises a threshold number of specific category or categories of PDUs of the PDU set having already been lost or discarded.

In a twenty fifth example, the method of the twentieth example, wherein the first and second discard timers, or first and second discard timer values, are pre-configured.

In a twenty sixth example, the method of the twentieth example, wherein both the first and second discard timer values are zero.

In a twenty seventh example, the method of the twentieth example, wherein the first and second discard timer values are different.

In a twenty eighth example, a processor configured to perform any of the methods of the first through twenty seventh examples.

In a twenty ninth example, a user equipment (UE) configured to perform any of the methods of the first through twenty seventh examples.

In a thirtieth example, a method, comprising processing, based on signals received from a user equipment (UE), UE preference information relating to a preference of a UE to discard protocol data units (PDUs) within a PDU set, processing, based on signals received from a network, configuration information that includes a PDU set discard configuration relating to which PDUs in the PDU set to discard and determining whether to discard one or more PDUs within the PDU set based at least in part on the UE preference information and the PDU set discard configuration.

In a thirty first example, the method of the thirtieth example, wherein the processing circuitry discards some PDUs within the PDU set.

In a thirty second example, the method of the thirtieth example, wherein the processing circuitry is configured to determine whether to discard one or more PDUs within the PDU set based on additional information in addition to the UE preference information and the PDU set discard configuration, wherein the additional information comprises one or more of transmission status, network status, network internal logic, and a configuration of an application function (AF).

In a thirty third example, the method of the thirtieth example, wherein the UE preference information is based on a battery level or power status of the UE.

In a thirty fourth example, the method of the thirtieth example, wherein the UE preference information is based on whether the UE is acting as a last node in relaying data to another device.

In a thirty fifth example, the method of the thirtieth example, wherein the UE preference information is based on a computation cost to recover from discarded PDUs and an internal status of the UE.

In a thirty sixth example, the method of the thirtieth example, wherein the UE preference information is received via a UEAssistanceInformation or other Radio Resource Control (RRC) message.

In a thirty seventh example, the method of the thirtieth example, wherein the UE preference information changes over time and the method further comprises processing, based on updated signals received from the UE, updated UE preference information relating to discarding of subsequent PDUs within the PDU set and determining whether to discard one or more PDUs within the PDU set based at least in part on the updated UE preference information.

In a thirty eighth example, the method of the thirtieth example, wherein the UE preference information comprises a recommendation to discard redundant or non-mandatory PDUs even if there is no congestion.

In a thirty ninth example, the method of the thirtieth example, wherein the UE preference information comprises an indication that discarding redundant or non-mandatory PDUs is allowable.

In a fortieth example, the method of the thirtieth example, wherein the UE preference information comprises a recommendation that redundant or non-mandatory PDUs not be discarded.

In a forty first example, the method of the thirtieth example, wherein the UE preference information comprises an indication of a preferred minimum number of PDUs in the PDU set that are successfully delivered before PDUs in the PDU set are to be discarded.

In a forty second example, the method of the thirtieth example, wherein the UE preference information further comprises an indication that PDU discarding is to be performed when congestion is detected at the network.

In a forty third example, the method of the thirtieth example, wherein the UE preference information further comprises an indication that PDU discarding is to be performed when a PDU Set Importance (PSI)-based discarding mechanism for a corresponding Data Radio Bearer (DRB) is activated.

In a forty fourth example, the method of the thirtieth example, wherein the UE preference information further comprises an indication that PDU discarding is to be performed when a threshold number of previous consecutive PDU Sets are already lost or discarded, or successfully delivered.

In a forty fifth example, the method of the thirtieth example, wherein the UE preference information further comprises an indication that PDU discarding is to be performed when a threshold number of previous PDU Sets have been lost or discarded within a specific time interval.

In a forty sixth example, the method of the thirtieth example, wherein the UE preference information comprises at least one level of discarding for each category of PDUs.

In a forty seventh example, the method of the forty sixth example, wherein each of the categories of PDU has a different level of discarding and each PDU of the PDUs in the PDU set is divided into one of mandatory PDUs, redundant PDUs, and recommended PDUs.

In a forty eighth example, the method of the forty seventh example, wherein the processing circuitry is configured to discard redundant PDUs.

In a forty ninth example, the method of the forty seventh example, wherein the processing circuitry is configured to discard all redundant PDUs and a subset of recommended PDUs.

In a fiftieth example, the method of the forty sixth example, wherein the at least one level of discarding for each of the categories of PDUs changes over time and the method further comprises processing, based on signals received from the UE, updated UE preference information relating to discarding of subsequent PDUs within the PDU set, the updated UE preference information comprising an updated level of discarding for each of the categories of PDUs and determining whether to discard one or more PDUs within the PDU set based at least in part on the updated UE preference information and the updated level of discarding.

In a fifty first example, the method of the forty seventh example, wherein the recommended PDUs are further divided into multiple different levels to discard and the processing circuitry is configured to determine which PDUs to discard per PDU set based on the multiple different levels.

In a fifty second example, the method of the forty sixth example, wherein a first level of discarding allows discarding of ten percent (10%) of PDUS.

In a fifty third example, the method of the fifty second example, wherein a second level of discarding allows discarding of up to twenty percent (20%) of PDUS.

In a fifty fourth example, the method of the fifty third example, wherein a third level of discarding level allows discarding of up to thirty-five percent (35%) of PDUs.

In a fifty fifth example, the method of the forty seventh example, wherein the method further comprises discarding redundant PDUs and transmit mandatory and recommended PDUs.

In a fifty sixth example, the method of the forty seventh example, further comprising discarding redundant and recommended PDUs and transmit only mandatory PDUs when congestion is above a predetermined threshold.

In a fifty seventh example, a processor configured to perform any of the methods of the thirtieth through fifty sixth examples.

In a fifty eighth example, a base station configured to perform any of the methods of the thirtieth through fifty sixth examples.

In a fifty ninth example, a method, comprising processing protocol data units (PDUs) within a PDU set and adaptively changing a discard timer or discard timer value to be applied to discard PDUs within the PDU set.

In a sixtieth example, the method of the fifty ninth example, further comprising applying a first discard timer or first discard timer value to PDUs within the PDU set, determining if one or more delivery conditions are met and, when the one or more delivery conditions are met, applying a second discard timer or second discard timer value to subsequent PDUs of the PDU set.

In a sixty first example, the method of the sixtieth example, wherein the one or more delivery conditions comprises a threshold number of PDUs of the PDU set having already been successfully delivered.

In a sixty second example, the method of the sixtieth example, wherein the one or more delivery conditions comprises a threshold number of PDUs having already been lost or discarded.

In a sixty third example, the method of the sixtieth example, wherein the one or more delivery conditions comprises a threshold number of specific category or categories of PDUs of the PDU set having already been successfully delivered.

In a sixty fourth example, the method of the sixtieth example, wherein the one or more delivery conditions comprises a threshold number of specific category or categories of PDUs of the PDU set having already been lost or discarded.

In a sixty fifth example, the method of the sixtieth example, wherein the first and second discard timers, or first and second discard timer values, are pre-configured.

In a sixty sixth example, the method of the sixtieth example, wherein both the first and second discard timer values are zero.

In a sixty seventh example, the method of the sixtieth example, wherein the first and second discard timer values are different.

In a sixty eighth example, a processor configured to perform any of the methods of the fifty ninth through sixty seventh examples.

In a sixty ninth example, a user equipment (UE) configured to perform any of the methods of the fifty ninth through sixty seventh examples.

In a sixty ninth example, a base station configured to perform any of the methods of the fifty ninth through sixty seventh examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as ios, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
create user equipment (UE) preference information relating a preference of a UE to discard protocol data units (PDUs) within a PDU set; and
generate, for transmission to a network node, a message comprising the UE preference information, wherein the UE preference information is configured to be used by the network node to discard one or more PDUs within the PDU set.

2. The apparatus of claim 1, wherein the UE preference information comprises a recommendation to discard redundant or non-mandatory PDUs.

3. The apparatus of claim 1, wherein the UE preference information comprises an indication that discarding redundant or non-mandatory PDUs is allowable.

4. The apparatus of claim 1, wherein the UE preference information comprises a recommendation that redundant or non-mandatory PDUs are not to be discarded.

5. The apparatus of claim 1, wherein the UE preference information comprises an indication of a preferred minimum number of PDUs in the PDU set that are successfully delivered before PDUs in the PDU set are to be discarded.

6. The apparatus of claim 1, wherein the UE preference information further comprises an indication that PDU discarding is to be performed when congestion is detected at the network node.

7. The apparatus of claim 1, wherein the UE preference information further comprises an indication that PDU discarding is to be performed when a PDU Set Importance (PSI)-based discarding mechanism for a corresponding Data Radio Bearer (DRB) is activated.

8. An apparatus comprising processing circuitry configured to:
process, based on signals received from a user equipment (UE), UE preference information relating to a preference of a UE to discard protocol data units (PDUs) within a PDU set; and
process, based on signals received from a network, configuration information that includes a PDU set discard configuration relating to which PDUs in the PDU set to discard; and
determine whether to discard one or more PDUs within the PDU set based at least in part on the UE preference information and the PDU set discard configuration.

9. The apparatus of claim 8, wherein the processing circuitry discards some PDUs within the PDU set.

10. The apparatus of claim 8, wherein the processing circuitry is configured to determine whether to discard one or more PDUs within the PDU set based on additional information in addition to the UE preference information and the PDU set discard configuration, wherein the additional information comprises one or more of transmission status, network status, network internal logic, and a configuration of an application function (AF).

11. The apparatus of claim 8, wherein the UE preference information comprises a recommendation to discard redundant or non-mandatory PDUs even if there is no congestion.

12. The apparatus of claim 8, wherein the UE preference information comprises an indication that discarding redundant or non-mandatory PDUs is allowable.

13. The apparatus of claim 8, wherein the UE preference information comprises a recommendation that redundant or non-mandatory PDUs are not to be discarded.

14. The apparatus of claim 8, wherein the UE preference information comprises an indication of a preferred minimum number of PDUs in the PDU set that are successfully delivered before PDUs in the PDU set are to be discarded.

15. An apparatus comprising processing circuitry configured to:
process protocol data units (PDUs) within a PDU set; and
adaptively change a discard timer or discard timer value to be applied to discard PDUs within the PDU set.

16. The apparatus of claim 15, wherein the processing circuitry is configured to:
apply a first discard timer or first discard timer value to PDUs within the PDU set;
determine if one or more delivery conditions are met; and
when the one or more delivery conditions are met, apply a second discard timer or second discard timer value to subsequent PDUs of the PDU set.

17. The apparatus of claim 16, wherein the one or more delivery conditions comprises a threshold number of PDUs of the PDU set having already been successfully delivered.

18. The apparatus of claim 16, wherein the one or more delivery conditions comprises a threshold number of PDUs having already been lost or discarded.

19. The apparatus of claim 16, wherein the one or more delivery conditions comprises a threshold number of specific category or categories of PDUs of the PDU set having already been successfully delivered.

20. The apparatus of claim 16, wherein the one or more delivery conditions comprises a threshold number of specific category or categories of PDUs of the PDU set having already been lost or discarded.
